(19) United States
(12) Patent Application Publication
(10) Pub. No.: US 2011/0163021 A1
(43) Pub. Date: Jul. 7, 2011

(54) GRAY WATER UTILIZATION SYSTEM HAVING AERATOR CONTROL

(75) Inventor: Ulrich Ehlert, Windeck (DE)

(73) Assignee: SPINFLOW GmbH, Windeck (DE)

(21) Appl. No.: 13/062,380

(22) PCT Filed: Jul. 29, 2009
(86) PCT No.: PCT/EP2009/005493

§ 371 Date: Mar. 4, 2011

(30) Foreign Application Priority Data
Sep. 4, 2008 (DE) 10 2008 045 686.1

(51) Int. Cl. C02F 1/44; B01D 65/00; E03B 1/04

(52) U.S. Cl. 210/137

(57) ABSTRACT

The invention relates to a grey water utilisation system comprising a grey water container, a clear water container, a membrane filter and an air pump as well as at least one first air line from the air pump to the membrane filter, said membrane filter including a filter housing which includes a grey water side and a clear water side, and wherein a connection line is arranged between the clear water side of the filter housing and the clear water container for transporting clear water from the filter housing into the clear water container, wherein a valve arrangement controllable by a control is provided between the air pump, the first air line and a second air line, which valve arrangement connects in a first position the pressure side of the air pump with the first air line and connects in a second switching position the pressure side of the air pump with the second air line, so that in the second position a pressure can be generated on the clear water side of the filter housing.

The present invention relates to grey water utilisation systems having a grey water container, a clear water container, a membrane filter and an air pump as well as at least one first air line from the air pump to the membrane filter, wherein the membrane filter includes a filter housing which has a grey water side and a clear water side, and wherein a connection line between the clear water side of the filter housing and the clear water container for transporting clear water from the filter housing into the clear water container is arranged. The membrane filters used here may be plate-shaped, foil-shaped or tube-shaped.

The term grey water is used to describe the shower and bath water used in households, which is not charged with faeces. Grey water can be processed by means of suitable filtration in such a way that it can be used for certain purposes in the household instead of drinking water. The filtrate is referred to as clear water. It is hygienically clean. Possible applications may be garden irrigation, toilet flushing and the use for laundering.

In known systems, for example from the prospectus “Weise Water Systems GmbH: MicroClear—Getauchte Ultrafiltration für kostbares Wasser, pages 1 to 12”, the grey water flows into a clarification device that includes two chambers. In one chamber, the grey water is temporarily stored, in the other chamber, the clear water is collected. A set of filters is arranged in the grey water chamber, which is made up from membrane filters and is ventilated by means of an air pump, the grey water side of said filter set being in communication with the grey water container, whereas the clear water or filtrate side is in communication with the filtrate chamber via a pipe. The flow of clear water from the membrane filter into the clear water container occurs as a result of the pressure differential which is generated from the difference between the filling levels in the grey water chamber and in the clear water chamber. Inevitably, therefore, the water level in the clear water chamber can rise no further than up to the filling level of the grey water chamber. As a consequence, if the grey water level is low, the clear water level will remain low as well. The amount of grey water that is present as the reference will not be filtered until clear water is taken out again. The clear water buffer which will then be available is therefore limited by the amount of grey water present.

It is therefore the object of the present invention to improve a grey water utilisation system with the least possible effort in such a way that any grey water present can already be filtered into clear water, even if the grey water level in the container arrangement does not exceed the clear water level.

This object is achieved by means of a device having the features of Claim 1.

Since a valve arrangement controllable by means of a control is provided between the air pump, the first air line and a second air line, which in a first position connects the pressure side of the air pump with the first air line and which in a second switching position connects the pressure side of the air pump with the second air line, so that in the second position pressure can be generated on the clear water side of the filter housing, this pressure may be used in order to elevate the clear water from the filter housing into the clear water container.

If further the valve means comprise at least one 3/2 way solenoid valve between the air pump and the second air line, this solenoid valve can be used in the first switching position for connecting the filter housing with the atmosphere and in the second switching position for introducing pressurised air into the filter housing.

It is also advantageous if the connection line between the filter housing disposed in the grey water container and the clear water container is a riser pipe which is taken in a vertical direction up to the level of an overflow of the grey water container, because in this case a hermetically sealed passage through the separating wall between the grey water container and the clear water container below the grey water level may be dispensed with. The system may also be implemented with two separate tanks which may be installed in the ground or in the house. As a result of the system design according to the invention it will then be possible to achieve a particularly large useable volume for the clear water container.

It may further be advantageous to provide a channel on the clear water side of the filter housing between a volume directly adjacent to the membranes and a volume connected to the connection line, which channel includes a non-return valve in order to avoid an application of pressure on the membrane during the removal process. In this way, a pressure load on the membrane is avoided. On the other hand, in the case of certain operating conditions an advantage may be achieved in that the pressure acting on the membranes during the removal process causes backwashing of the membranes.

An exemplary embodiment of the invention will be described in more detail below with reference to the drawing.

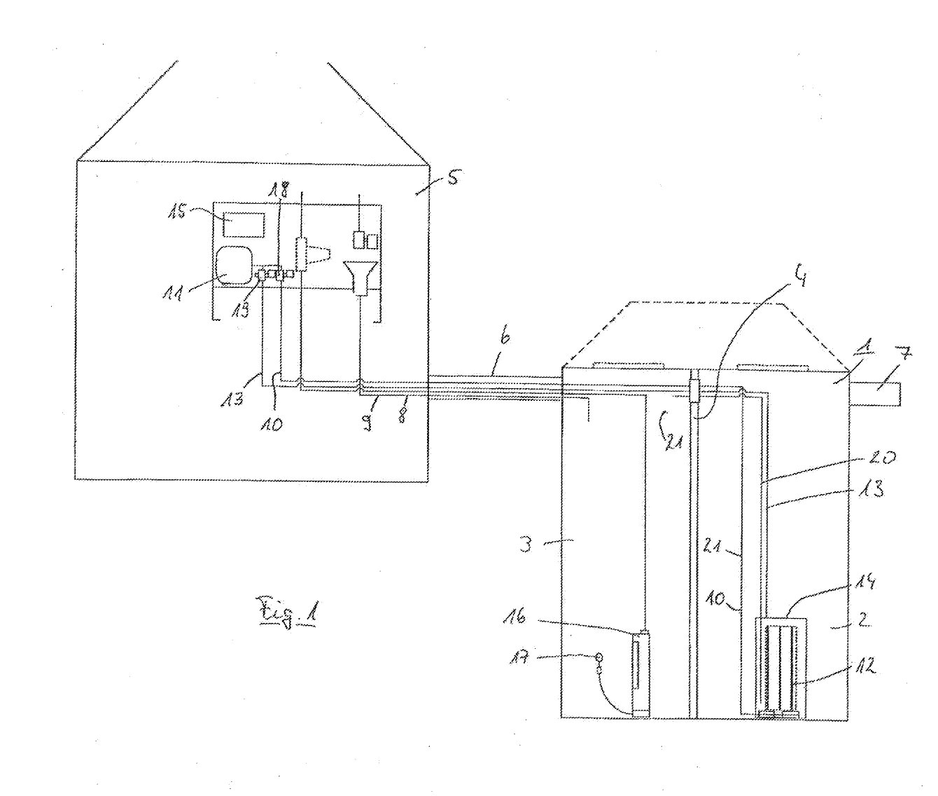

FIG. 1 shows a schematic view of a grey water treatment system comprising a container 1 which includes a grey water chamber 2 and a clear water chamber 3. The two chambers are separated from each other by a separating wall 4. The container 1 is disposed outside of a residential building 5, for example below ground level. A duct 6 takes connection lines, which will be described in more detail below, from the residential building to the container. An overflow 7 discharges any excess grey water into the drainage system.

The lines running within the duct 6 comprise a drinking water refeeding line 8, a clear water line 9 which leads from the clear water container 3 into the residential building 5, a first air line 10 from an air pump 11 to a ventilator 22 of a set of membrane filters 12, as well as a second air line 13 that leads into a housing 14 of the set of membrane filters 12. The introduction of grey water into the grey water container 2 is achieved by means of a discharge line (not shown) through the duct 6.

Further, electric connections are provided between a control 15 and the air pump 11 as well as other electric units which are not shown here in detail.

In order to transport clear water from the clear water container 3 through the clear water pressure line 9 into the residential building 5, a submersible pump 16 is disposed in the clear water container 3. The submersible pump 16 is controlled for example by an integrated pump control and takes clear water via a floating removal device 17. It builds up the water pressure in the clear water pipe 9, which is needed for removal in the residential building.

The air pump 11 builds up an airstream during operation, which is present at a positive pressure on a first solenoid valve 18 and a second solenoid valve 19 which are connected in parallel. In the open condition, the first solenoid valve 18 feeds the airstream into the first air line 10 in order to feed the ventilator 22, whilst the second solenoid valve 19 feeds the second air line 13 in the open condition. The two solenoid valves 18 and 19 are controlled by the control 15. The valve 18 may be a 2/2 way solenoid valve, whereas valve 19 is preferably a 3/2 way solenoid valve, in order to alternatively enable ventilation and atmospheric pressure compensation on the clear water side of the filter housing.

During operation, grey water flows from the residential building 5 into the grey water container 2 and is present there on the grey water side of the set of membrane filters 12. The air pump 11 is set in motion by the control 15 and delivers an airstream via the open first solenoid valve 18 through the first air pipe 10 via the ventilator 22 to the bottom surface of the set of membrane filters 12. Air bubbles then pearl along the grey water side of the membrane 12 and continuously clean the membrane. Also, the aerobic biological system is supplied with oxygen in this process. The second solenoid valve 19 is here closed towards the pressure side of the air pump 15. It connects the second air line 13 with the atmosphere. Grey water flows from the grey water side of the set of membrane filters 12 through the membranes into the clear water side of the set of filters, which is located in the same housing 14. The clear water side is, with the exception of the set of membrane filters 12, hermetically sealed against the grey water side. Sets of membrane filters of this type are known from the prior art. The air supplied via the ventilator 22 below the set of membrane filters 12 escapes on the grey water side of the set of membrane filters 12 through the grey water chamber 2 into the atmosphere. Due to the initially present height difference between the grey water level in the grey water container 2 and the initially empty clear water side in the filter housing 14, water is pushed through the set of membrane filters 12 and the clear water level with the filter housing 14 rises. Due to the pressure differential, this rise of the clear water level during the filtering process will only continue until the level of both liquids is the same.

In order to now transport the clear water out of the filter housing 14, the solenoid valve 18 is closed by the control 15. The air pump 11 continues to operate. The solenoid valve 19 is opened by the control 15, so that the airstream is fed into the second air line 13. This air line terminates in the filter housing 14 on the clear water side. On the clear water side, a pressure builds up in the housing 14, which elevates the clear water through a riser pipe 20 and takes it via the free outlet 21 into the clear water container 3. Once the clear water supply in the filter housing 14 has been emptied to such a degree that the second air line 13 blows out freely, this will be detected by the control 15, for example on account of the pressure present in the second air line 13 or by means of a filling level sensor. The solenoid valve 19 is then closed again and the solenoid valve 18 opens, so that the air stream of the air pump 16 is again available for cleaning the set of membrane filters 12. The pressure differential now created between the present grey water and the clear water side in the filter housing 14 causes the filtration process to continue.

The control may also be carried out via the filling level on the clear water side or as a cyclic timing control.

The clear water in the clear water container 3 is now available for removal through the submersible pump 16. In this way, clear water may be delivered from the filter housing 14 into the clear water container 3 by means of the arrangement as described so far, and this up to a level that is clearly above the grey water level in the grey water container 2. To this end, in the simplest case, only the two solenoids valve 18 and 19 shown as well as the second air line 13 are required. A separate elevating pump for delivering the clear water into the clear water container 3 may be dispensed with. This is therefore a simple and cost-effective design of a grey water utilisation system, which enhances the availability of clear water.

In an extended embodiment, the line 13 may be connected in a known manner to a vacuum pump during the filtration process, in order to accelerate filtration on account of the negative pressure generated.

The arrangement shown in the drawing of air pump, control, drinking water refeed and solenoid valves may also be arranged, in a particularly compact design, in a module in the clear water container. The module will then be attached in such a way that it will always be above the water level. The elevating pump 16 will then operate in an extended control also as a safety pump which will pump, once a maximum filling level in the clear water container has been reached, part of the clear water away, for example back into the grey water container. The components necessary in the module may be particularly well protected against corrosion, because the clear water container and the grey water container are not connected to each other atmospherically as this has been the case so far, so that no corrosive gases can get from the biological grey water treatment into the area of the module. The system thus designed may be delivered in a pre-assembled condition in a particularly simple manner. The assembly effort is limited to the erection and the connection of electricity, drinking water as well as grey water infeed and clear water pressure line.

### LIST OF REFERENCE NUMERALS

1. Container
2. Grey water chamber
3. Clear water chamber
4. Separating wall
5. Residential building
6. Duct
7. Overflow
8. Drinking water feed-in line
9. Clear water pipe
10. Air line
11. Air pump
12. Set of membrane filters
13. Air line
14. Housing
15. Control
16. Submersible pump
17. Removal device
18. Solenoid valve
19. Solenoid valve
20. Riser pipe
21. Outflow
22. Ventilator

1. A grey water utilisation system comprising a grey water container, a clear water container, a membrane filter and an air pump as well as at least one first air line from the air pump to the membrane filter, said membrane filter including a filter housing which includes a grey water side and a clear water side, and wherein a connection line is arranged between the clear water side of the filter housing and the clear water container for transporting clear water from the filter housing into the clear water container, wherein a valve arrangement controllable by a control is provided between the air pump, the first air line and a second air line, which valve arrangement connects in a first position the pressure side of the air pump with the first air line and connects in a second switching position the pressure side of the air pump with the second air line, so that in the second position a pressure can be generated on the clear water side of the filter housing.

2. The grey water utilisation system according to claim 1, wherein the clear water side of the filter housing is connected with the atmosphere in the first switching position of the valve arrangement.

3. The grey water utilisation system according to claim 1, wherein the valve arrangement comprises at least one 3/2 way solenoid valve between the air pump and the second air line.

4. The grey water utilisation system according to claim 1 wherein the clear water side of the filter housing is connected in the first switching position of the valve arrangement via the valve arrangement with the atmosphere.

5. The grey water utilisation system according to claim 1 wherein the connection line between the grey water container and the clear water container is a riser pipe, which is taken in a vertical direction up to the level of an overflow of the grey water container.

6. The grey water utilisation system according to claim 1 wherein, on the clear water side of the filter housing, a channel is provided between a volume directly adjacent to the membranes and a volume connected to the connection line, which channel includes a non-return valve in order to avoid any application of pressure on the membrane during the removal process.
